(19) United States
(12) Patent Application Publication
(10) Pub. No.: US 2020/0074881 A1
(43) Pub. Date: Mar. 5, 2020

(54) CENTERLINE FACE-FORWARD METHOD OF PUTTING

(71) Applicant: On Cue Golf Inc., Portland, OR (US)

(72) Inventor: Mike ROSKOPF, Portland, OR (US)

(21) Appl. No.: 16/678,950

(22) Filed: Nov. 8, 2019

Related U.S. Application Data
(63) Continuation of application No. 16/239,347, filed on Jan. 3, 2019.
Application No. 16/239,347 is a continuation of application No. 15/834,842, filed on Dec. 7, 2017, now abandoned.
Application No. 15/834,842 is a continuation of application No. 14/954,748, filed on Nov. 30, 2015, now abandoned.

(51) Int. Cl. G09B 19/00

(52) U.S. Cl. CPC G09B 19/0038; A63B 69/3676

(57) ABSTRACT

A method for a golfer to putt a golf ball over the surface of a green toward a hole comprises selecting a target line on the green, assuming a stance next to the ball facing the hole, addressing the ball by gripping the shaft of a putter and positioning it behind the ball with the hands generally facing toward one another in front of and facing the golfer's body, executing a backstroke by drawing the hands toward the body's vertical centerline to swing the arms rearwardly about an axis of rotation through the shoulders to take the putter head away from the ball along a rearward extension of the target line, and transitioning to and executing a forward stroke by moving the hands in a forward direction away from the golfer's body to swing the arms about the axis of rotation to stroke the putter head to strike the ball for rolling it along the target line.

### FIELD OF THE DISCLOSURE

The present disclosure relates to the game of golf and to a method for putting a golf ball along a predetermined target line on a green. The method is based on the golfer assuming a face-forward position at all times during the putting stroke, and the method complies with the rules of golf. The United States Golf Association (USGA) and the Royal and Ancient (R & A), the bodies which govern the rules of golf, recently adopted Rule 14-1b which bans anchoring the club. This rule directly affects those golfers who use a putting method where the club, the putter, is “anchored.” The rule goes into effect on Jan. 1, 2016 and states that in making a stroke a player must not anchor the club “directly” or by use of an “anchor point.” The rule notes that a club is anchored directly when the player intentionally holds the club or a gripping hand in contact with any part of the body, except that a player may hold the club or a gripping hand against a hand or the forearm.

An “anchor point” also exists when the player intentionally holds a forearm against any part of the body to establish a gripping hand as a stable point around which the other hand may swing the club. The issue with anchoring the club has come up principally in connection with the putting stroke. The USGA and the R & A wish to preserve the fundamental nature of golf where the player swings the golf club. Numerous players over the last several years have adopted so-called “anchor putting,” and they will have to abandon this style and variants thereof as of Jan. 1, 2016. The penalty for prohibited anchored putting in violation of this rule is loss of hole in match play and two strokes in stroke play.

Many professional and amateur golfers have used an anchored putting technique for many years. Professional golfers on the PGA tour have won tournaments with key putts holed out, all while using an anchored putting stroke of some kind, soon to be outlawed. These players all started their golf careers by adopting a conventional putting stroke, and based upon needing improved scoring, adopted anchored putting.

Now all golfers have to live with rule 14-1b. The method of the present disclosure offers an alternative for those players that have to change, and for that matter, all players, whether competing on the circuit, at a club or on municipal courses, who want to take advantage of a method where the golfer faces forward while executing a putting stroke.

### BACKGROUND OF THE DISCLOSURE AND EXAMPLES OF THE PRIOR ART

Putting in golf is a very important part of the game of golf. It has been estimated that as much as 40% and even more of a golfer's strokes executed in a round of golf in both the professional and amateur ranks are counted as putts. With such a high number, it only stands to reason that hundreds of different putting stances, grips, putter head and shaft designs and configurations and styles have been experimented with literally over the life of this ancient game. Putting styles are highly individualistic, and many golfers have sought valiantly yet perhaps vainly to develop techniques directed to increasing the chances of making a putt, regardless of the distance to a hole and the line that the ball must be putted to be successful.

In the traditional putting stroke, assuming a right-handed golfer, a stance is assumed where the golfer faces the ball and then endeavors to take the putter head in the backstroke so the face of the putter head follows the target line to the golfer's right. Then the golfer transitions to the forward stroke, swinging the putter to the left, still endeavoring to keep the putter face square all the way through impact, and follow-through. Keeping the face square to the target line is difficult, some advocate that the left arm remain bent throughout. Some professionals and golf instructors maintain that the left arm should control the action throughout, others say the right, and still others suggest that neither arm controls, that the arms should work together.

Regardless, the left hand pushes and the right hand pulls in the backstroke whereas the left hand pulls and the right hand pushes after the transition to the forward stroke and throughout the forward stroke. Instructors may urge players to keep the hands relatively inactive, the putting stroke is made by the shoulders, the big muscles, all the better, they say, in making sure the putter head or the face remain square by feeling the action of the putting stroke principally in the shoulders.

Virtually all advise that the body be positioned close enough to the ball so that the player can bend at the waist comfortably and position the head so the eyes can look directly over the ball. The head is to remain still or just slightly swivel during the phases of the stroke. As the golfer looks down the target line, in position to putt, to reassess the distance, it is necessary to turn the head to the side to look toward the hole. But the eyes do not look at the hole straight on, full binocular vision, so necessary for accurate depth perception, cannot be utilized. The golfer then has to return the eyes to look at the ball, and the distance to the hole has to be somehow kept in mind, as the golfer makes the putting stroke.

Many believe proper technique requires that the shoulders must rock aback and forth, and that the arms swing about a pivot point visualized on the neck. The right shoulder must rock up and the left shoulder down on the backstroke, and the opposite on the forward stroke.

The value of using binocular vision in a putting stance has been advocated over the years, most famously by Sam Snead who adopted a croquet style putting technique in 1966 where he faced the hole, straddled the ball and executed the stroke. His hands were placed far apart, but the croquet style, where the feet straddle the ball was outlawed by the USGA and R & A beginning Jan. 1, 1968, in what has been called “unconscionable,” as being directed at one person, and a famous one at that. Undaunted, Snead then went to a putting style called “side saddle,” where he still faced the hole but the ball was to the side of his body and in front of his right foot. He bent forward an extreme amount, well beyond 45 degrees, essentially crouched down, and gripped the putter with the hands spaced far apart. The left hand gripped the putter near the top, in front of the chest, and the right hand cradled the shaft with the fingers, palm facing forward very low on the shaft.

Another croquet-style disclosure that preceded Snead, much lesser known perhaps, is the method described in Duden (U.S. Pat. No. 3,062,549). The golfer depicted there faces the hole and is positioned astride of the ball with the eyes directly above the ball. The ball is in between the feet, and the golfer grips the club, lets the arms hang so the elbows lightly touch the sides of the body, and the putting stroke, croquet-style is made. The patent describes a putter specially designed with a shaft having upper and lower portions subtending an oblique angle with respect to each other in a plane normal to the ball striking surface.

Sam Snead's side saddle putting style lives yet today, having spawned numerous modifications, many of which are subject of patents, included as part of the information disclosure statement (IDS) submitted here. A recent adaptation can be seen on the website www.linksofutopia.com, where a method called “Putt Face-On” is demonstrated, and putters designed to implement the method are offered for sale. The method looks a lot like Snead's side saddle format but has some variations. In the “Putt Face-On” method, a putter with a long shaft and long grip is used. The first step is to grip the top of the club with the non-putting hand, thumb on top of grip, to become a “hinge.” Then the putting hand is placed about a foot and a half lower on the grip in one of two suggested fashions. The left elbow is then braced against the body, and this is described as a stabilizer. The ball is about six to 12 inches in front of and to the outside of the right foot, and the left hand is placed directly over the body. The golfer leans to the outside of the right foot to align eyes. Then the putting stroke, is made, advised to be “straight back, straight through.”

### SUMMARY OF THE DISCLOSURE

The present disclosure is directed to a method for a golfer to putt a golf ball along a predetermined target line on the green of a golf course in which the golfer stands adjacent the ball and faces forward so both eyes look directly at the hole. The golfer assumes an athletic stance by flexing the knees slightly and bending forward at the waist comfortably. For a right-handed golfer, the stance is taken so that the ball is several inches in front of and outside of the right foot, and using the target line as a guide, the golfer aligns the body so that its vertical axis or centerline, if extended straight forward could be visualized by the golfer as an auxiliary line on the ground running to the left of and generally parallel to the target line. The golfer allows the arms to hang down naturally and grips the shaft with the hands generally facing toward one another so they fall into position generally in front of the body's vertical centerline. The golfer extends the shaft of the putter diagonally from the hands to position the face of the putter head behind the ball and square to the target line.

The complete putting stroke may now be executed, starting with the backstroke by drawing the hands back toward the body's vertical centerline to swing the arms and the shaft rearward to bring the shaft by the outside of the right leg and the putter head away from the ball generally along a rearward extension of the target line. At the end of the backstroke the golfer transitions to the forward stroke which is executed by moving the hands in a forward direction away from but generally aligned with the body's vertical centerline to swing the arms and shaft forwardly to direct the putter head so that its face strikes the ball to roll it along the target line.

Advantages of the present disclosure will be more readily understood after considering the drawings and the detailed description which follow.

### BRIEF DESCRIPTION OF THE DRAWINGS

FIG. 1 is a front view of a golfer set-up to address the ball with a putter in a stance centered-up to face forward to look directly at a hole on the green where the arms hang down naturally and the golfer grips the putter shaft with the hands generally facing toward one another generally in front of the body's vertical centerline to extend the shaft diagonally to position the face of the putter head behind the ball and square to the target line in accordance with the putting method of the present disclosure.

FIG. 2 is an enlarged view of a portion of FIG. 1 showing the golfer's forearms and hands gripping the shaft so that an intermediate portion on the shaft is generally aligned with the body's vertical centerline in accordance with the present disclosure.

FIG. 3 is a perspective view of the golfer in FIG. 1 oriented to show projection of the golfer's vertical centerline so that if extended in front of the body it would generally project a vertical central plane running in front of the body and intersecting the ground along a line which could be visualized by the golfer, looking ahead, to extend parallel to and spaced inside of the target line in accordance with the present disclosure.

FIG. 4A is a view taken from the right of the golfer in FIG. 1 where the golfer is assuming a stance set-up to address the ball by gripping the putter with the arms hanging down naturally and positioning the putter head behind the ball in accordance with the present disclosure.

FIG. 4B is a view shown in outline, taken from above, of the feet, ball position and the putter head behind the ball, when the golfer is set-up to address the ball in the position of FIG. 4A (as well as in FIGS. 1 and 3), showing the feet positioned generally parallel to one another so that an imaginary line can be visualized interconnecting the front ends of the golfer's shoes to intersect the target line generally at a right angle thereto in accordance with the present disclosure.

FIG. 5A is a view of the golfer of FIG. 4A showing execution of the backstroke to completion by flexing of the wrists back and drawing the hands toward the body's vertical centerline to swing the arms rearward about an axis of rotation which extends generally through the shoulders to take the putter head away from the ball generally along a rearward extension of the target line in accordance with the present disclosure.

FIG. 5B is a view shown in outline, taken from above, of the feet, ball position and the putter head at the completion of the backstroke corresponding to FIG. 5A in accordance with the present disclosure.

FIG. 6A is a view of the golfer executing the forward stroke by moving the hands forward away from the body's vertical centerline from the position shown in FIG. 5A to swing the arms forward and strike the ball in accordance with the present disclosure.

FIG. 6B is a view shown in outline, taken from above, of the feet, ball position and the putter head to strike the ball corresponding to FIG. 6A in accordance with the present disclosure.

FIG. 7A is a view of the golfer executing the forward stroke to completion by moving the hands forward away from the body's vertical centerline and following through by releasing the hands after the ball is struck in accordance with the present disclosure.

FIG. 7B is a view shown in outline, taken from above, of the feet and the putter head after completion of the follow-through corresponding to FIG. 7A in accordance with the present disclosure.

The drawing figures illustrate embodiments and schematic concepts of the present disclosure, and the purpose of these drawings is to aid in explaining the principles of the method of the present disclosure. Other embodiments of the method of putting disclosed here may be created which follow the principles as taught herein, and these other embodiments are intended to be included within the scope of patent protection.

### DETAILED DESCRIPTION OF THE DISCLOSURE

### Overview of the Method

As stated at the outset, the present disclosure is directed to a method for a golfer to putt a golf ball along a predetermined target line on the green of a golf course in which the golfer assumes a stance adjacent the ball and faces forward so both eyes look directly at the hole. The golfer assumes an athletic stance by flexing the knees slightly and bending forwardly at the waist comfortably. For a right-handed golfer, the stance is taken so that the ball is several inches in front of and outside of the right foot, and using the target line as a guide, the golfer aligns the body or squares it up so that its vertical axis or centerline, if extended straight forward, can be readily visualized by the golfer as an auxiliary line on the ground running to the left of and generally parallel to the target line.

The golfer positions the putter so that the putter head is behind the ball and the putter face is squared up to the target line. The shaft is gripped with the hands generally facing toward one another, and the arms are allowed to hang down in front of the body naturally so the hands fall into position generally in front of the body's vertical centerline. The putter shaft is positioned to extend diagonally from the hands to sole the putter head with its face maintained behind the ball and square to the target line. The golfer may make adjustments to this set-up after looking at the hole and the target line, to set the putter face as dead square to the target line as the golfer is visually capable of doing.

The complete putting stroke may now be executed, starting with the backstroke by the golfer drawing the hands back toward the body's vertical centerline to swing the arms and the shaft rearward to bring the shaft by the outside of the right leg and the putter head away from the ball generally along a rearward extension of the target line. At the end of the backstroke the golfer transitions to the forward stroke, executed by moving the hands in a forward direction away from but generally aligned with the body's vertical centerline to swing the arms and shaft forwardly and accelerate the putter head to direct the putter face to strike the ball and roll it along the target line. The golfer may then complete the forward stroke by following through with the arms and allowing the hands to release smoothly.

With this basic overview of the method, there follows a more detailed explanation of its implementation in the entire putting stroke as shown in the drawings. An analysis of the execution of the backstroke is given, including the set-up, addressing the ball, the takeaway and execution of the backstroke itself. Thereafter follows an explanation of the transition after completion of the backstroke, including the forward stroke, striking the ball so it rolls along the target line and the follow-through. While the description proceeds with respect to a right-handed golfer, the same method would be used by a left-handed golfer, the difference being a reversal in the positioning of the hands, taking a stance so the ball is positioned several inches in front of and outside of the left foot, etc.

### The Setup and Addressing the Ball

The goal of putting, regardless of style, is to develop rhythm and tempo ensuring a smooth roll of the ball along the target line. Distance control and speed control are paramount, and the face of the putter head must be held as square as possible to the target line during the backstroke and through-stroke at impact, release and follow-through. These are the principal objectives of any well-executed putting stroke, and the method of the present disclosure provides the basic stance and setup which greatly facilitate these objectives.

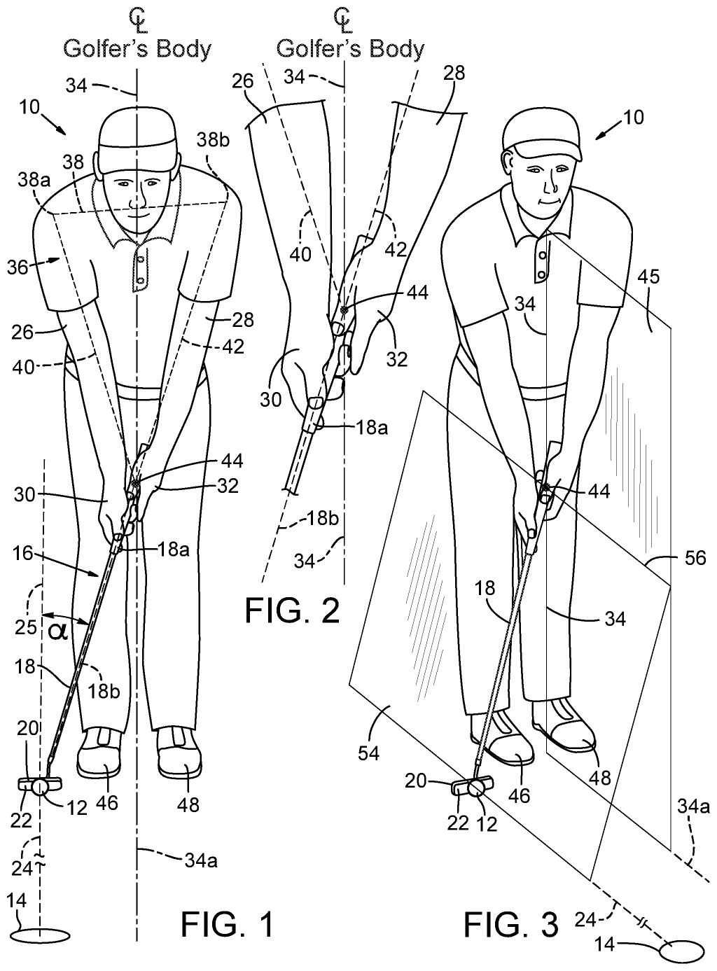

As shown in FIGS. 1 and 2, a golfer 10 is shown in the basic set-up to be used in the method of the present disclosure to putt a golf ball 12 over the surface of a green toward a hole 14 using a putter generally indicated at 16. The putter includes a shaft 18 and a handle 18a. A hosel mounts a putter head 20 to the shaft, and a putter face which is the surface on the putter head for striking the ball is shown at 22. A predetermined starting line or target line on the green along which the ball is to be putted is shown at 24.

The terms “starting line” and “target line” may to some have slightly different meanings, but target line will be used here as meaning that line along which the golfer intends to putt the ball. The target line may be directly in line with the hole, or to the left or right of it, depending on how the golfer reads the green for a break or even multiple breaks. The term “target line” will be used with the understanding that this is the line on which the ball is to roll directly all the way to the hole, or that line which the golfer wishes to stroke the ball and have it follow for a certain distance, after which the ball is to fall off to one side or the other to “break” toward the hole. In any case, “target line” will be used here as meaning that line along which the golfer intends to putt the ball.

The target line is shown directed straight to the hole in FIG. 1, but it could be directed to either the right or left side depending on the contour of the green and the amount of breaks or even multiple breaks as read by the golfer. Regardless of ultimate direction, the golfer needs to select a target line and stroke the putter head so the putter face strikes the ball square to the target line to roll the ball along the target line. Key to any good putting stroke is distance control and speed control along with alignment of the putter face square to the target line. This is important for any putt, regardless of distance to the hole, but many putts may be in the 15 to 25-foot range, and to hole them out and not just try for a “tap-in” on the next putt is a challenging goal.

While no method can ensure success, it is believed that using binocular vision, where depth perception is optimized, enhances a golfer's ability to putt by visualizing or gauging distance to the hole more accurately than conventional methods. Judging distance works with the golfer's ability to visualize and the internally feel the speed with which the putting stroke must be executed to send the putt with sufficient pace to reach the hole. Binocular vision has been recognized before as helpful, and many solutions have been tried. The present disclosure takes advantage of binocular vison by a method which utilizes a unique set-up and stroking protocol.

FIG. 1 is a view looking directly at the golfer who has assumed a stance next to ball 12 to face generally in the direction of the hole. The stance shown here illustrates the proper set-up and address position prior to the takeaway or initiating the backstroke. The knees are flexed slightly, and the golfer bends comfortably at the waist without crouching, allowing the right and left arms, 26 and 28, respectively, to hang down naturally. The golfer is shown gripping the shaft with the right and left hands, 30 and 32, respectively, generally facing toward one another and positioned generally in front of a vertical centerline 34 of the golfer's body. The stance ensures that weight is distributed generally evenly over both feet, and the golfer is in a stable position, which will be maintained during the putting stroke. The body is not twisted or turned relative to vertical centerline 34, the body is squared up, symmetrically positioned about the vertical centerline.

The longitudinal axis of putter shaft 18, shown at 18b, must be inclined at a lie angle, shown at a when the putter head is soled against the green, to be offset generally in the range of 14 to 17 degrees relative to the vertical shown at 25. As shown also in FIG. 2, the golfer has adopted a reverse overlap grip, where the forefinger of the left hand overlaps between the third and fourth fingers of the right hand. But the overlap grip, where the fourth finger of the right hand overlaps between the forefinger and the index finger of the left hand could be adopted, or others depending on preference of the golfer.

In the FIG. 1 view, looking directly at the golfer, it can be seen that an upside-down triangle, generally indicated at 36, can be visualized having a base, or axis of rotation 38 (shortly to be explained) extending to and generally aligned with the shoulder joints 38a and 38b at their approximate locations. The sides of the triangle, indicated at 40 and 42, extend downwardly, generally along the length of the golfer's right and left arms, respectively, to intersect approximately at an apex or what may be thought of as an intermediate portion, indicated at 44, on handle 18a of shaft 18 (see FIG. 2). The intermediate portion on the handle aligns generally with vertical centerline 34 of the golfer's body. (The intermediate portion is shown on the left thumb in FIG. 2, but actually is on the handle, behind the thumb.) This alignment is the natural positioning of the handle, when the arms are hanging down naturally, essentially unrestricted, with elbows “soft,” and the golfer gripping handle 18a with the hands generally facing toward one another. There is no need for undue conscious manipulation for this position to be attained. This is a very comfortable stance for the golfer to assume, it is an athletic, tension-free position because the arms are hanging down naturally in front of the body. The arms hang in a position to swing easily in unison and symmetrically about the shoulder joints in the same direction and at the same time during the backstroke and forward stroke, in a manner to be described.

The base of the triangle or axis of rotation 38, which lines up to extend between the shoulder joints, remains to a large extent almost parallel to the ground, duplicating the slight incline of the shoulders, due to one hand gripping the putter lower than the other. During a backstroke, the hands are drawn toward the body's vertical centerline to swing arms 26 and 28 rearward in unison about axis of rotation 38 to take putter head 20 away from the ball generally along a rearward extension of the target line. A forward stroke is executed by moving the hands in a forward direction away from the golfer's vertical centerline to swing the arms in unison about axis of rotation 38 to stroke putter head 20 so that it may be accelerated smoothly and rhythmically to strike the ball for rolling it end over end along the target line with sufficient pace to reach the hole.

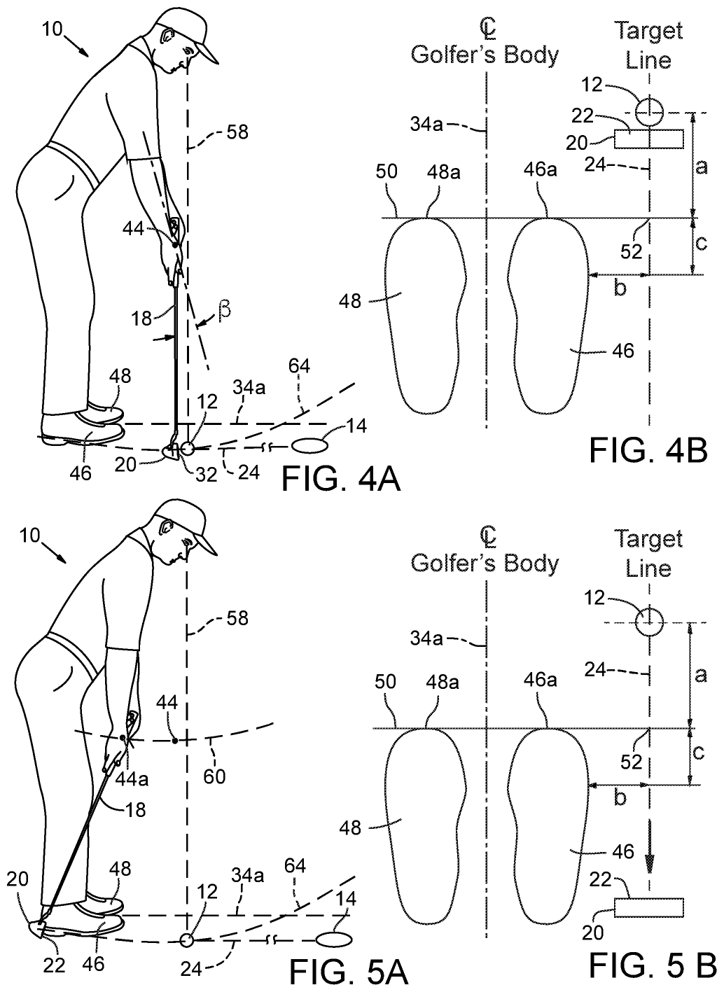

The following steps may be advantageously utilized by a golfer in the setup and addressing the ball and FIGS. 4A, 4B, 5A and 5B, along with FIG. 3 illustrate these steps in more detail. After a golfer has hit a ball to fly or roll onto the green, and assuming it has not landed in the hole, and has come to rest, it needs to be “holed out,” i.e. putted by the player into the hole before the game proceeds to the next hole. The first step is selecting the target line on the green along which the ball is to be putted. To determine the target line, the golfer approaches the ball and may stand directly behind it to face the hole and visualize the target line along which the ball must be rolled so that it has a chance to reach and enter the hole after execution of the putting stroke.

Generally on short putts, the target line can be visualized somewhat readily and with confidence. But encountered during a round there may be many putts of considerable distance, 15-25-footers, oftentimes longer. Plus the green must be read for contour, and possible breaks, even multiple breaks are common. This is an analytical challenge for every player, considered by many to be the mental and emotional, as well as scoring, heart of the game, regardless of putting method. Distance control and speed control are what every player seeks to optimize. The present method is believed to enhance the player's ability visually to judge distance, set-up and stroke the ball while achieving optimum balance and movement of the hands and arms. This is because the golfer will face directly toward the hole, so both eyes using a person's binocular vision can be used effectively to judge distance and thereby speed necessary for the ball to be stroked to reach the hole.

After the target line has been determined, the golfer approaches the ball with the goal of assuming a stance next to the ball by positioning the body (see FIG. 3) so its vertical centerline 34, if extended to run in front of the body, would generally project a vertical central plane 45 intersecting the ground along an auxiliary line 34a. This auxiliary line can be visualized by the golfer, looking ahead, to extend parallel to and be spaced inside of target line 24. The golfer can visualize without undue effort how the body must be squared up to face forward to project in the mind's eye how the vertical centerline of the body could be extended along the ground as an auxiliary line 34a running substantially parallel to and spaced inside of target line 24, as shown in FIGS. 1 and 3. The golfer can refine this basic orientation further by consciously placing the feet parallel to one another next to the ball in a manner to be described, which orients the body so that it is squared up with its vertical centerline as described and shown in FIGS. 1 and 3.

This position is important because once achieved, and with the putter head positioned behind the ball, and the putter face squared to the target line, the golfer can look at the hole and the target line with both eyes, facing straight ahead, and by tilting the head slightly downwardly, can look directly at the target line and follow it all the way back to the ball and where the putter face is set-up square to the target line. The golfer can look several times and gain reassurance that the direction of the target line is sound.

By looking with both eyes directly at the target line and the hole, utilizing binocular vision to help mentally fix the distance that the ball must travel, the golfer gets a good feel of how much impact force must be directed by the putter head against the ball during the putting stroke so the ball can at least reach the hole. By the golfer assuming the face-forward position during the backstroke and forward stroke the golfer can feel the hands following along the central vertical plane, and consequently knows that the putter head is substantially tracking along the target line. Of course the putter head will move slightly inside the target line during the backstroke and after impact, but this is a minor amount. What the golfer essentially feels is an overall stroke that follows a straight path during the backstroke and forward stroke.

There are different ways to assume an optimal set-up position for addressing the ball, but a recommended method is as follows. After the target line is determined, the golfer positions putter head 20 behind the ball so that putter face 22 is generally square to the target line, as shown in the diagram view of FIG. 4B, as well as in the views of FIGS. 1, 3 and 4A. The golfer now needs to position the feet, such as shown at 46 and 48, relatively close and generally parallel to one another with vertical centerline 34 extending between them as auxiliary line 34a running parallel to target line 24. To assume this position, as shown in FIG. 4B, the golfer grips the handle of the putter with the hands generally facing one another and with the arms hanging down naturally and generally aligned with the vertical central line, and moves to position the feet generally as shown in FIG. 4B. This position can be visualized by the golfer, and can be seen to approximate a position where an imaginary line 50 interconnecting front ends 46a and 48a of the golfer's shoes extends generally perpendicular or normal to target line 24 to intersect it at 52. The shoulders are squared up, they are not turned or twisted, the chest faces straight forward with the shoulders oriented generally parallel to the line interconnecting the front of the golfer's shoes. A line interconnecting the shoulders would extend generally perpendicular or normal to the target line as well.

The golfer must be positioned behind the ball and to the left thereof, again as shown in FIG. 4B, so the putter is able to swing outside of the golfer's right leg, as will be explained. With the feet positioned as described, and the golfer looking straight ahead with the shoulders generally lined up parallel to the imaginary line interconnecting the feet, the golfer can visualize auxiliary line 34a. Generally the golfer should position the feet so that the distance to the center of the ball measured from where imaginary line 50 intersects target line 24 is in the range of about four to seven inches, represented by “a” in FIG. 4B. The approximate distance from the widest part of the shoe closest to the ball, which is right foot 46, measured to a rearward extension of target line 24, is in the range of about three to five inches, represented by “b.” The distance represented by “c” depends on shoe size, but for most golfers is in the range of about three to five inches. All of this can be visualized by the golfer without undue effort.

The golfer addresses the ball by allowing the arms to hang down naturally and gripping shaft 18 by its handle 18a with the hands generally facing toward one another and positioned generally in front of vertical centerline 34. This positions intermediate portion 44 between the hands on the shaft to be generally aligned with vertical centerline 34. In this position and for the arms to hang down naturally, and for the putter head to be positioned as shown, at least a portion of the longitudinal axis of putter shaft 18, shown at 18b, must be diagonally extend from the golfer's hands to the proper position behind the ball.

The putter must be inclined at a lie angle, when the putter head is soled against the green, to be offset generally in the range of 14 to 17 degrees relative to the vertical. This is shown in FIG. 1, where the angle a is shown measured between longitudinal axis 18b of the shaft and the vertical, shown at 25, which extends upwardly from target line 24. Inasmuch as FIG. 1 is a front view, vertical 25 coincides with a rearward extension of target line 24, if projected downwardly. The lie angle as described is a necessary built-in feature of the putter as used; it is not contemplated that the golfer would manipulate the hands or anything else significantly to assume the stance and set-up or adopt the address position and arrangement as described. The lie angle is necessary for the club to be positioned diagonally at set-up and to swing by the right leg during the backstroke and the through stroke.

As shown in the perspective view of FIG. 3, the lie angle of longitudinal axis 18b of shaft 18 means that during the backstroke and forward stroke the longitudinal axis or the shaft itself extending from the hands generally tracks or scribes an inclined plane 54. The inclined plane intersects vertical central plane 45 at 56, and the ground generally along target line 24. The vertical central plane and the inclined plane are approximations of how the putter shaft travels, individual differences in stroke adherence, set-up, swing rhythm, physiology and other factors of course influence aspects of the putting method disclosed.

The set-up and address, as described, put the golfer in an athletic, comfortable position, facing the hole head-on, with the body's centerline looking ahead. Doing so, the golfer adopts a position to take advantage of binocular vision, and is able to execute a repeatable putting stroke because it is natural, comfortable, and brings the hands, forearms and arms into synchronous play. Vision, balance and movement combine to give the golfer an opportunity to maximize the putting stroke, as will be considered further now.

As shown in FIG. 4A, the golfer is in proper set-up position to address the ball. The arms are hanging down naturally, and shaft 18 is plumb, or seen to be vertical when viewed from the right side of the golfer as shown. The golfer is shown looking straight down at the ball, not looking back to see where it is. The golfer can look at the hole, and then back down on the ball and the target line to check alignment. The next step is for the golfer to employ a “trigger,” a movement that will initiate the beginning of the backstroke.

### The Takeaway and Backstroke

A trigger found useful is the so-called forward press. The golfer, although in an athletic, balanced stance, is principally static in set-up and must change smoothly and rhythmically from that mode to an active one for the takeaway to be fluid. This may be done by the golfer urging the hands to press slightly forward to tilt shaft 18 in the forward press to initiate movement. The golfer now executes the backstroke, as shown in FIG. 5A, by flexing the wrists backwardly and then pulling the hands toward the body's vertical centerline to swing the arms rearwardly in unison about axis of rotation 38 which extends generally through the shoulders (see FIG. 1). This takes putter head 20 away from ball 12 generally along a rearward extension of the target line, and the hands move back so that intermediate portion 44 on handle 18 traces an arc 60, as shown in FIG. 5A. Note: intermediate portion 44 is shown on the golfer's right hand because its position on handle 18a is hidden on the other side of the hand in the right side views of FIGS. 4A, 5A, 6A and 7A.

The golfer may choose to flex the wrists further in the backstroke, the amount being deemed necessary by the golfer, in conjunction with shoulder action, to accelerate the putter head in the forward stroke with sufficient striking force against the ball so that it will roll the entire distance needed. While distance to the hole is a factor, so are contours of the green, including its breaks and slope, and of course the golfer's own experience and ability to judge. All these are factored mentally by the golfer in producing an effective swing with sufficient pace in the forward stroke.

FIGS. 5A and 5B show completion of the backstroke. The shaft has swung by the side of the golfer's right leg, and putter head 20 has reached its maximum distance back away from the ball. FIG. 5B shows this position, and the golfer has achieved it by swinging the putter so that its shaft passes outside of the right leg, and to the rear, with the putter head generally following along the rearward extension of the target line.

As shown in FIG. 5A, the golfer is looking along sight line 58 at the center of the ball, and may continue to do so if desired, but the golfer may keep the head in the same position throughout the backstroke and merely by moving the eyes follow the putter head back to ensure that the putter face is held generally square to the target line. The head is in a comfortable position, and its orientation very still because the arms swing about an axis together, not jostling the body, one shoulder does not go up, and the other down. The smoothness of the pendulum-like arm action helps vision, balance and movement.

### Transition, Forward Stroke, Impact and Follow-Through

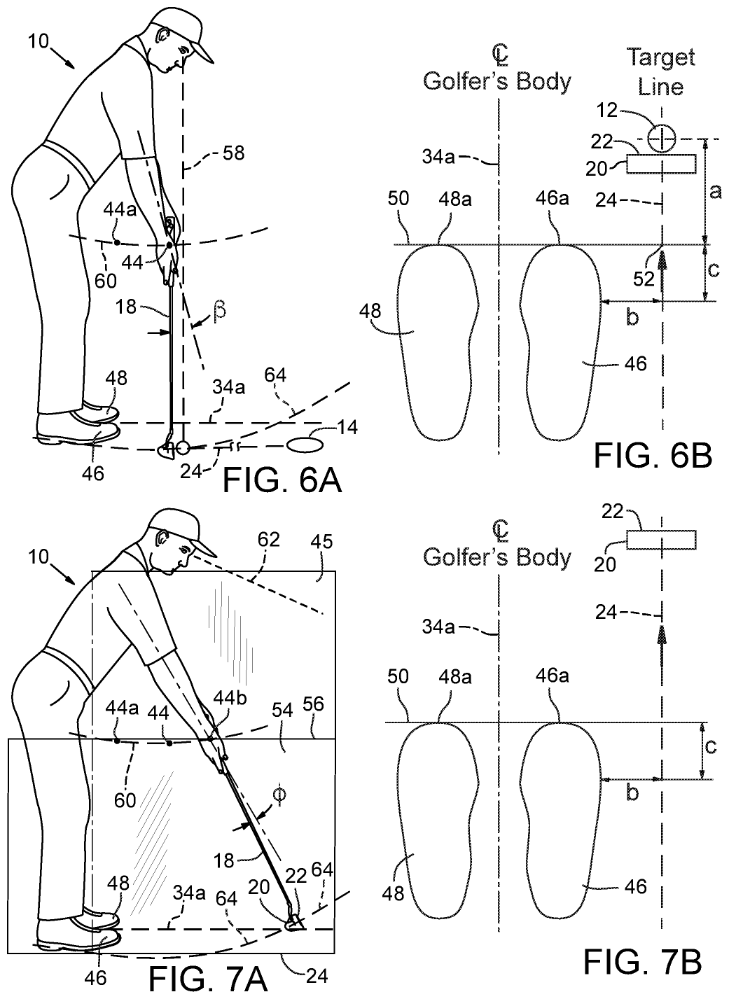

As shown in FIG. 5A intermediate portion 44 on the handle follows an arc denoted by 60 as the golfer completes swings the arms and hands in the backstroke. The position of the intermediate portion on the handle on arc 60 at the completion of the backstroke is denoted at 44a in the drawing. The golfer must now transition to the forward stroke. This is accomplished by moving the hands in a forward direction away from the golfer's vertical centerline to swing the arms in unison about axis of rotation 38 to accelerate putter head 20 so that putter face 22 will strike ball 12 squarely for rolling it along the target line. FIGS. 6A and 6B show the forward stroke just before impact with the ball, and here the golfer continues to concentrate on the ball, and shaft 18 and putter head 20 have returned almost to the same position they occupied at set-up, as shown in FIG. 4A.

There may be some differences, depending on the amount of wrist flex and how much of the flex has been released at this point. The angle β may be different than in the case of the set-up shown in FIG. 4A and just prior to impact. It is to be noted that intermediate portion 44 on shaft 18 has returned generally along arc 60 that it had traced during the backstroke. The shaft has swung forward past the golfer's right leg and the golfer concentrates on the ball and continues to accelerate the swing while focusing on putter face 22 striking the ball square to the target line to roll it along the target line.

As the putter face strikes the ball, the golfer's head may remain relatively quiet, in position to look at the impact area where the putter face has hit the ball, as the hands and arms flow into the follow-through, even after the ball has rolled away. Gradually the golfer may raise or tilt the head up, and look forward to make sure that the putter head “chases” the ball as it rolls along the target line, and see whatever direction it may eventually take. Hopefully that will be all the way as the golfer watches for the ball to approach the hole and then drop. The follow-through and slight raising of the head to look ahead as shown by the raised line of sight 62 are shown in FIG. 7A.

The golfer has extended the hands and arms in the follow-through to complete the forward stroke. The hands fully release from their flexed position, and the angle Φ between the long axis of the arms and the longitudinal axis of shaft 18, where they intersect at intermediate portion 44a, has closed from that of angle β as shown in FIGS. 4A and 6A because of the hands have been released to align more with the extension of the arms in the follow-through. The ball is well on its way to follow the target line as closely as the golfer has been able to execute the putting stroke, and hopefully the ball will have sufficient speed to roll into the hole.

The view of FIG. 7A also shows vertical central plane 45 and inclined plane 54. The hands of the golfer swing back and then forward relative to the vertical centerline, during the backstroke and the forward stroke, respectively, and conclude with the follow-though. The intermediate portion on the handle, being substantially aligned with the vertical centerline, travels along arc 60 and approximately tracks along vertical central plane 45 extending in a forward direction from the vertical centerline of the golfer's body. The putter head throughout the backstroke, forward stroke and follow-through traverses an arc 64, shown as it ascends in the follow-through with release of the hands, pictured in FIG. 7A.

The various positions of the intermediate portion of handle 18a, generally arcing along the plane, or felt by the golfer to follow generally aligned above auxiliary line 34a are shown at 44, 44a and again at 44 and finally at 44b. The longitudinal axis 18b of shaft 18 generally sweeps along the surface of inclined plane 54 during the putting stroke, but it bears emphasis that these planes are generally visualized, and generally represent the action and alignment of the hands and the putter shaft. They are illustrated here to show this action generally, and how the golfer can visualize these planes, if need be, during the entire putting stroke. The essential feeling of the golfer, however, is that the backstroke and forward stroke can be executed by a simple swing directed back toward, and then away from the vertical centerline of the golfer's body.

### Advantages to the Method of Putting in the Present Disclosure

The centered-up, face-forward stance described here places the golfer in an athletic position, ready for action, optimizing vision, balance and movement in executing a controlled and rhythmical putting stroke. The golfer faces the action, like a shortstop faces a batted ball, like a tennis player awaiting a serve, like a basketball player shooting a free-throw. The golfer may look directly at the hole and see how far the ball is from to the hole; this is done by taking advantage of the body's natural ability to judge distance spatially through its inherent binocular vision. Weight is distributed substantially equally over both feet, placed parallel to one another so the tips of the shoes line up substantially normal to the target line. The body is stable, no leaning to one side or the other, shoulders square and facing forward throughout the entire stroke sequence.

Distance control is more accurate, and speed control is enhanced as a result. The golfer may calculate mentally, and impart physically, the amount of force that must be exerted by the arms and hands during the putting stroke because distance has been judged well.

Most importantly, the set-up and swing of the putter and rolling of the golf ball after impact take place with the golfer looking directly at the ball, face-forward, and looking with both eyes focused directly on the ball. Because the arms hang down naturally in front of the body, the golfer can easily feel and use feel the hands, arms and shoulders in a simple motion, a simple swing to feel freedom and be clear of complicated thoughts. The hands and arms swing about the shoulders in unison, lined up symmetrically with respect to the body's vertical centerline to move in the same direction at the same time. Unlike a conventional putting stroke, the present method ensures that the shoulders remain generally squared up, one arm does not push while the other pulls in the backstroke, and then a reversal of that during the forward stroke. The shoulders have no need to rock, or “see-saw” or swivel in trying to keep the putter face square to the target line.

In the present method, the swing in the backstroke, forward stroke and follow-through is almost automatic with the hands positioned together and moving back toward and then forward away from the centerline of the golfer's body. The stance is easy to assume, and the set-up enables the swing to proceed almost reminiscent of a children's swing set. The putter head strikes the ball squarely with sufficient force to roll it smoothly along the target line to reach the hole and the hands release during the follow-through. The athletic stance enhances balance and movement during all sequences of the putting stroke. The centered-up, face-forward stance enables the golfer to look at the ball during the entire stroke.

The golfer is able to feel relaxed, relatively free of tension and use the hands and arms for feel. There is no need for the golfer to rigidly control the putter with the shoulders having to swivel or replicate a rocking motion to ensure a putter head traveling square along the target line, often emphasized in the traditional putting setup and stroke. In the present set-up and stroke, the golfer knows that the putter head will generally track the target line when the arms are swung because the hands generally follow the body's centerline in the backstroke and through-stroke to strike the ball and follow-through. The method of the present disclosure gives a golfer a reliable and repeatable putting stroke to propel the golf ball along the desired target line toward the hole with the desired pace or speed.

While embodiments of the present disclosure of a method of putting have been particularly shown and described, many variations may be made therein. This disclosure may include one or more independent or interdependent embodiments directed to various combinations of features, functions, elements and/or properties. Other combinations and sub-combinations of features, functions, elements and/or properties may be claimed later in a related application. Such variations, whether they are directed to different combinations or directed to the same combinations, whether different, broader, narrower or equal in scope, are also regarded as included within the subject matter of the present disclosure. Accordingly, the foregoing embodiments are illustrative, and no single feature or element, or combination thereof, is essential to all possible combinations that may be claimed in this or a later application.

What is claimed is:

1. A method for a golfer to putt a golf ball over the surface of a green toward a hole using a putter having a shaft and a putter head with a face, comprising:
selecting a target line on the green along which the ball is to be putted;
assuming a stance next to the ball to face generally in the direction of the hole;
addressing the ball by gripping the shaft of the putter and positioning the putter head behind the ball with the hands positioned in front of and facing the golfer's body;
executing a backstroke from the address position by drawing the hands toward the body's vertical centerline to swing the arms rearwardly in unison about an axis of rotation which extends generally through the shoulders thereby to take the putter head away from the ball generally along a rearward extension of the target line; and
transitioning to and executing a forward stroke by moving the hands in a forward direction away from the golfer's body to swing the arms in unison about the axis of rotation thereby to stroke the putter head to strike the ball for rolling it along the target line.

2. The method of claim 1 wherein the addressing step is further defined by allowing the arms to hang down naturally and gripping the shaft with the hands generally facing toward one another and positioned generally in front of the vertical centerline of the golfer's body.

3. The method of claim 2 wherein the step of assuming a stance next to the ball is defined by the golfer positioning the body's vertical centerline so that if extended in front of the body it would generally project a vertical central plane running in front of the body and intersecting the ground along a line which could be visualized by the golfer, looking ahead, to extend parallel to and spaced inside of the target line.

4. The method of claim 2 wherein the addressing step is further defined by gripping the shaft so that its longitudinal axis if extended would intersect at least approximately the target line.

5. The method of claim 3 wherein the steps of executing the backstroke and forward stroke to swing the arms are further defined by the hands gripping the putter so that an intermediate portion along the shaft between the hands is generally aligned with the vertical centerline of the golfer's body and approximately tracks along an arc on the vertical central plane extending in a forward direction from the vertical centerline of the golfer's body.

6. The method of claim 5 wherein the steps of executing the backstroke and forward stroke to swing the arms are further defined by the hands gripping the putter so that the longitudinal axis of the shaft extending from the hands generally tracks an inclined plane offset at an angle to intersect the vertical central plane and the target line.

7. The method of claim 6 wherein the addressing step is further defined by gripping the shaft so that the putter head is positioned behind the ball with at least a portion of the longitudinal axis of the putter shaft being inclined at a lie angle offset generally in the range of 14 to 17 degrees relative to the vertical.

8. The method of claim 7 wherein the step of assuming a stance next to the ball is defined further by positioning the feet to be generally parallel to one another so that an imaginary line interconnecting the front ends of the golfer's shoes extends to intersect the target line generally perpendicular thereto.

9. The method of claim 8 wherein the golfer positions the feet so that the distance to the center of the ball measured from where the imaginary line intersects the target line is in the range of about four to seven inches, and wherein the distance from the widest part of the shoe closest to the ball to a rearward extension of the target line is in the range of three to five inches.

10. A method for a golfer to putt a golf ball over the surface of a green toward a hole using a putter having a shaft and a putter head with a face, comprising:
selecting a target line on the green along which the ball is to roll after being putted;
assuming a stance next to the ball by positioning the body's vertical centerline so that if extended to run in front of the body would generally project a vertical central plane intersecting the ground along a line which could be visualized by the golfer, looking ahead, to extend parallel to and spaced inside of the target line;
addressing the ball by allowing the arms to hang down naturally and gripping the shaft with the hands generally facing toward one another and positioned generally in front of the vertical centerline of the golfer's body so that an intermediate portion between the hands on the shaft is generally aligned with the body's vertical centerline and the face of the putter head is oriented behind the ball generally square to the target line;
executing a backstroke from the address position by initially tilting the shaft slightly forward while flexing the wrists backwardly and then drawing the hands toward the body's vertical centerline to swing the arms rearwardly in unison about an axis of rotation which extends generally through the shoulders thereby to take the putter head away from the ball generally along a rearward extension of the target line;
transitioning to and executing a forward stroke by moving the hands in a forward direction away from the golfer's body to swing the arms in unison about the axis of rotation thereby to stroke the putter head so its face strikes the ball for rolling it along the target line; and
extending the hands and arms in a follow-through to complete the forward stroke.

11. The method of claim 10 wherein the backstroke is accompanied by a simultaneous flexing of the wrists felt necessary to provide ample acceleration of the putter head in the forward stroke for the face to strike the ball so that it has sufficient speed to travel along the target line to reach the hole.

12. The method of claim 11 wherein the steps of executing the backstroke and the forward stroke are further defined by the hands gripping the putter so that an intermediate portion along the shaft between the hands is generally aligned with the vertical centerline of the golfer's body and approximately tracks along an arc on the vertical central plane extending in a forward direction from the vertical centerline of the golfer's body.

13. The method of claim 12 wherein the forward stroke is further defined by releasing the wrists from their flexed position as the putter head strikes through the ball into full release in the follow-through.
